(19) United States
(12) Patent Application Publication
(10) Pub. No.: US 2006/0119582 A1
(43) Pub. Date: Jun. 8, 2006

(54) Unambiguous text input method for touch screens and reduced keyboard systems

(76) Inventors: Edwin Ng, Singapore (SG); Joo Seng Oh, Singapore (SG); Chin Foo Tan, Singapore (SG)

Correspondence Address: Albert Wai-Kit Chan;World Plaza, Suite 604, 141-07 50th Avenue, Whitestone, NY, 11357, US

(21) Appl. No.: 10/548,697

(22) PCT Filed: Mar. 2, 2004
(86) PCT No.: PCT/SG04/00046

§ 371 Date: Dec. 16, 2005

(30) Foreign Application Priority Data
Mar. 3, 2003 (SG) 200300895-0

(51) Int. Cl. G09G 5/00

(52) U.S. Cl. 345/168; 345/173; 345/179

(57) ABSTRACT

A method for entering text unambiguously. The method includes detecting, on a screen, sensor pad, or reduced keyboard system, a stroke across of an individual character or symbol; and displaying the character or symbol unambiguously. This allows for unambiguous inputting in reduced keyboard systems without the need of changing modes or auxiliary keys.

### FIELD OF THE INVENTION

This invention relates to unambiguous text-inputting for screens with sensors, sensor pads or pen based inputting on any keyboard systems or arrangement of characters. It also allows for an unambiguous text-inputting system to be implemented seamlessly for reduced keyboard systems, e.g. TenGO (Singapore Patent Application 200202021-2), to complement the ambiguous keystroke methods without having to have additional buttons, soft-keys or methods to change modes between ambiguous text-inputting and unambiguous text-inputting. This invention is also especially relevant for touch screen or soft-key text-inputting applications in mobile devices, mobile phones, handhelds, PDAS, pocket computers, tablet PCs, sensor pads or any pen-based and even virtual keyboard systems.

### BACKGROUND

The growth of PDAs, handhelds and mobile devices has been nothing short of phenomenal. Almost everywhere you turn and everyone is carrying a mobile device of sorts. One of the advents of the new era is the surge of online text based communication. Online text based communication, started with the computers and the Internet and continued to gain acceptance and popularity with Short Message Service (SMS). Email is now a de facto form of communication for both personal and business purposes and compact electronic devices are getting smaller, have more functionality and are more integrated. The singular direction headed by mobile phones, handhelds, PDAs and pocket computers is that it must have online text based communication in one form or another, be it emails, SMS or instant messaging (IM).

For text input, pen-based paradigm has dominated the handheld market, but there is a parallel trend towards using keyboard-based technology. Pen-based input uses a stylus, finger or object to either tap on a virtual keyboard on screen or scribble on screen using handwriting recognition to decipher the “digital ink” left by the scribbling. Pen-based tapping suffers from small virtual keyboard buttons being represented on screen or larger buttons which compromises display areas while pen-based scribbling (handwriting) though seemingly “more natural” is slow and not accurate enough to fulfil high user expectations. However, the ultimate bottleneck of handwriting input lies in the human handwriting speed limit. It is very difficult to write legibly at a high speed. Speed and efficiency wise, keyboard entry is still the fastest and most convenient for text based communication. Thus, with the heavy and increasing demand for online text based communication, many device manufacturers are forced to using a miniature full-sized QWERTY keyboard. The miniature keyboard, though visually appealing, leaves much to be desired for anything more than casual text input as the keys are too small and too close together. Because of this, reduced keyboard systems using predictive text input are another alternative that seems promising because of the limitation of space and larger buttons, but the problem arises when keying in words that are not part of the library or database which usually requires mode change to a more inefficient mode of text inputting (i.e. non-predictive or unambiguous text input) like multi-tap or two-keystroke methods. Examples of the more conventional unambiguous text input methods of multi-tap, two-keystroke or multiple-stroke interpretation are described in U.S. Pat. Nos. 6,011,554 and 6,307,549 for reduced keyboard systems.

There have been various attempts to improve unambiguous text inputting for both pen-based tap method and reduced keyboard system like incorporating a forward prediction engine for the pen-based tap method. The main problems with pen-based tap methods are that they still require tapping on virtual buttons that are too small for accurate inputting thus creating frustration when frequently tapping on the wrong key and necessitating a considerable amount of concentration and focus when tapping. Thus, it is not surprising that users are currently using mobile text-based applications like emails and word processing for reading only and not for writing. Text inputting on mobile devices are most of the time limited to only short messages, short notes and filling contact information.

In the present invention for screen text input, instead of tapping on a character key, you simply stroke across the character. By implementing this stroke or scribing method for unambiguous pen-based text inputting, it requires less concentration and focus and is more accurate because of the more tolerant flexibility of scribing which allows inaccurate start points, fast adjustments at only a very slightly longer step process than tapping. Fast adjustments are also made more easily because of the digital ink trace left behind on the virtual keyboard during the scribe. The digital ink trace gives a distinct visual feedback to the user to properly guide the user to make any adjustments quickly to scribe the correct character. The beauty of the design for pen-based text inputting is that it does not require a change in form factor for the device and can be implemented on any virtual keyboard design or character arrangement and character type (e.g. Chinese characters, Japanese characters, Chinese and Japanese stroke symbols, etc.) The scribing methodology has a dual functionality in reduced keyboard systems by making unambiguous text inputting seamless with ambiguous text inputting (i.e. without the need for a mode change button). The seamlessness is created by virtue of our invention being able to identify two different types of inputting on the same key (i.e. a tap versus a scribe). This allows the multi-character key of the reduced keyboard system to function as normal for ambiguous text inputting when tapped and to accept unambiguous text inputting when scribed. This applies equally to reduced keyboard systems using physical keys by simply providing more degrees of freedom to the keys allowing it to move counter to a tapping direction and thus, simulating a stroke for individual characters. This is implemented either by having a multi-directional (with the normal tap mechanism) button be the multi-character key or by having the multi-character key consists of individual keys that could be moved counter to the tapping direction.

Gesture or stroke based inputting itself is not new in that it has been used in computer systems as a “shortcut” for command operations like open file, close file, run file, etc. For pen based text input systems, it is also used in the Windows CE standard keyboard to make it easier to enter basic characters in their capital form. This is done by touching the letter to be capitalised and sliding the pen up and the capital version of the touched letter is displayed. The Windows CE standard keyboard also detects a backspace by sliding the pen to the left and a space if the pen is slid to the right. In the U.S. Patent Application 20030014239, sliding is also used in pen based text inputting to input accented and other extended characters by having different sliding directions and length of slide determine various versions or customised output of the touched letter. The main problem of the Windows CE standard keyboard and the U.S. Patent Application 20030014239 is that it still requires touching on the small virtual button/key representing the letter before sliding. In our scribing method, you can literally start the slide by touching the button space of another letter and then slide through the detection region of the letter you want to input that character. Another major difference is that in our invention, scribing not tapping is used in the actual selection of the letter we want, while in the other solutions mentioned sliding is used to select an alternate form of the letter selected like accented, capital, extended characters or even command based functions while still relying on tapping for actual selection of the letter. The only case where our invention uses scribing in congruence with tapping is when it is used on virtual multi-character keys to create a seamless switch between ambiguous and unambiguous text inputting. The using of a slide method to seamlessly distinguish ambiguous and unambiguous text inputting for reduced keyboard systems have been covered in U.S. Pat. No. 6,286,064, but the sliding motion still necessitates first touching each symbol on each key precisely. Also, in all prior art, the required character is only displayed on lifting of the pen from the screen or after a certain length is slid to identify the distinct direction of the sliding motion which is a slower process than our invention whereby the character can be displayed on contact of the scribing motion with a detection region.

Our invention is further enhanced with the use of digital ink trace and line detection regions that allows quicker detection, and even the versatility of having functions like the spacebar to be shrunk to a line or thin bar, thus saving space but yet being able to place the line spacebar in more strategic locations to speed up text-inputting on a virtual keyboard.

### SUMMARY

An aspect of the invention provides for a method for a screen text input system, wherein to input a data value or data symbol on a virtual keyboard unambiguously using a gesture and stroke text input method comprising the steps of using a finger or object to stroke across a character representative of a keystroke on a virtual keyboard on the screen; detecting the touch on the screen; detecting the stroking motion from the point of contact on the screen; matching location points of the stoking path with detection regions on the screen, which are assigned data value or data symbols representative of the character displayed on the screen, it is located on or nearby; and displaying as text input the data value or data symbol assigned to the detection region that is stroked across.

An embodiment may include besides a stroke across other gestures like circling, crossing, crisscrossing and zigzagging over the character and have the same functionality as a stroke across. Additionally, the gestures would leave behind a digital ink trace on the virtual keyboard during gesturing.

Another embodiment of the method wherein the matching of location points of the stroking path with detection regions on the screen, are done in the order of matching with the most likely or common detection region first to the least likely or common detection region last.

A further embodiment of the method wherein the detection region representative of the character is a detection box within or covering the character and the detection box can be of any shape and size. Additionally, the detection region could be a detection line across or near the character. Also, the detection line could be visible on the keyboard. Furthermore, a spacebar could be represented by a single line or thin bar on the virtual keyboard wherein it is selected as per a detection line

Another further embodiment may further comprise the step of displaying the data value or data symbol in a different case like upper case, diacritic and accented type case or even as a function, if an auxiliary key or sticky auxiliary key (sticky means needing only to press the auxiliary key once without need to keep holding down the key to work in concert with other keys—e.g. sticky shift) is used in concert with the gesture.

A yet further embodiment of the method may have the character displayed being the first character gestured over ignoring any subsequent characters that could have been gestured over. Alternatively, the character displayed is the last character gestured over ignoring any previous characters that could have been gestured over. Another variant is that the character displayed is the character that was gestured over the most ignoring any other characters that have been gestured over less. For a detection line, the character that is gestured over the most is the character that was gestured closest to the centre of the detection line. Yet another variant wherein characters are displayed for each character that was gestured over in the order of which they were gestured over.

A still further embodiment of the method wherein the screen could be a touch screen or sensor pad, or a screen or virtual screen that works with a sensor object or sensor like in pen-based inputting.

Another embodiment of the method wherein the character could be one of the characters in a multi-character key. Additionally, the embodiment will perform as per a multi-character key input, if the character or multi-character key representing the character is tapped instead of stroked across.

Another aspect of the invention provides a screen text input system comprising: a display routine displaying a virtual keyboard on screen; a stored set of data values or data symbols assigned to various detection regions on the virtual keyboard representative of the displayed characters on the virtual keyboard; an input routine which detects a touch on the virtual keyboard and a scribing path of the contact with the virtual keyboard; a matching routine which matches the detection regions of the virtual keyboard with the scribing path and determines which detection region(s) is selected; and an output routine that displays the data value or data symbol representative of the detection region(s) selected.

An embodiment wherein the system incorporates the method of inputting for a screen text input system.

Another aspect of the invention provides a method of inputting for a reduced keyboard system, with a plurality of keys, each key having at least one feature wherein the feature is a data value, a function or a data symbol representative of a keystroke on a keyboard, wherein a key is a multi-character key consisting of individual keys, representative of the consisting individual data value or data symbol, that can move in a counter motion to the normal motion of tapping on the multi-character keys, wherein to input a character unambiguously does not require changing modes between ambiguous and unambiguous text-inputting using a stroke text input method comprising the steps of: moving the individual character key in a direction counter to tapping as per normal for a multi-character key input; and displaying the data value or data symbol representative of the individual character key. Alternatively, instead of the multi-character key consisting of individual character keys, it is a single button that can be moved in multiple directions besides tapping, wherein each direction represents the stroke text input method of moving the consisting individual character key counter to tapping.

Another embodiment may further comprise the step of displaying the data value or data symbol in a different case like upper case, diacritic and accented type case or even as a function, if an auxiliary key or sticky auxiliary key is used in concert with moving of the individual character key counter to tapping.

Another embodiment may further comprise the step of performing as per a multi-character key input, if the button representing the character is tapped instead of stroked and moved counter to tapping. Additionally, if more than one individual character key from the same multi-character key set is tapped together, it would still perform as per a single multi-character key input.

Another aspect of the invention provides a reduced keyboard system for inputting information comprising: a plurality of keys, each key having at least one feature wherein the feature is a data value, a function or a data symbol representative of a keystroke on a keyboard wherein a key is a multi-character key consisting of individual character keys, representative of the consisting individual data value or data symbol, that can move in a counter motion to the normal motion of tapping on the multi-character keys; a database for storing data wherein the data is a data character or a data symbol associated with an input keystroke sequence of the keys; and a display for displaying the information.

A further embodiment wherein to input a character unambiguously does not require changing modes between ambiguous and unambiguous text-inputting by moving a individual character key in a direction counter to tapping as per normal for a multi-character key input.

A yet further embodiment wherein instead of the multi-character key consisting of individual character buttons; it is a single button that can be moved in multiple directions besides tapping, wherein each direction represents the equivalent of moving of the consisting individual character key counter to tapping.

Another embodiment wherein the multi-character key functions as per a multi-character key input when tapped. The multi-character input could be using any existing reduced keyboard system such as those described in U.S. Pat. Nos. 5,818,437; 5,945,928; 5,953,541; 6,011,554; 6,286,064, 6,307,549, and Singapore Patent Application 200202021-2.

### BRIEF DESCRIPTION OF THE DRAWINGS

These and other features, objects, and advantages of embodiments of the invention will be better understood and readily apparent to one of ordinary skill in the art from the following description, in conjunction with drawings, in which:

FIG. 1 shows how an on-screen keyboard (conventional QWERTY keyboard) could look like on a touch screen or screen input surface.

FIG. 1a shows how an on-pad keyboard (conventional QWERTY keyboard) could look like on a sensor pad.

FIG. 2 shows how an on-screen reduced keyboard system (e.g. TenGO) could look like on a touch screen or screen input surface.

FIG. 3 shows how individual characters on an on-screen keyboard are stroked across (scribed) and the display of the text input that follows.

FIG. 4 shows examples of detection regions.

FIG. 4a shows an example of line detection region.

FIG. 5 shows scribing methodology applied to a hard-key reduced keyboard system with multi-character keys consisting of individual buttons.

FIG. 5a shows scribing methodology applied to a hard-key reduced keyboard system with joystick-like multi-character keys.

FIG. 6 is a block diagram showing the main components associated with the software program of this invention.

FIG. 7 is a flowchart depicting the main steps associated with the operations of the software program of this invention.

FIG. 8 is a flowchart depicting the main steps associated with the input routine of the software program of this invention.

### DETAILED DESCRIPTION

Throughout this description, the embodiments shown should be considered as examples, rather than as limitations on the present invention.

As mobile devices shrink in size and continues to encompass more text-based computing applications that require text-inputting like emails and word processing, the challenge is to present to the user a text-inputting solution that is not only fast, easy, and intuitive, but also to be able to be used for sustained or extended text-inputting.

Currently, there are two main genres of solutions, the hardware based text-inputting methods like miniature keyboards and the software based text-inputting methods which mainly encompass either pen-based or touch screen solutions like handwriting recognition and virtual keyboards or hands-free solutions like speech recognition. Speech recognition though seemingly a compelling alternative to typing and having gone through much improvement, is still plagued with issues of inaccuracies, long training and learning periods, speed, privacy, and other human factors like its usually more natural to think and type than to talk and think. Because of space constraint and limitations, hardware based solutions like miniaturised keyboards with their tiny buttons and keys are difficult to type and errors happen often from pressing the wrong neighbouring keys. Pen-based solutions are not too much better off with handwriting recognition still being largely inaccurate, slow and requiring long learning practices to train the recognition software. Other pen-based solutions like the virtual keyboard encounters the same pitfalls as their hardware counterparts in that the small area allocated to the virtual keyboard also begets tiny buttons which require a lot of concentration and focus to type on and mistypes are frequent. Clearly, all these solutions are unable to provide a suitable text-inputting platform for sustained or more intensive text-inputting.

We have recognised that there are two main directions to create a more comprehensive mobile text-inputting solution. One is for a more efficient method than tapping on tiny virtual keyboard buttons, another is for a reduced keyboard system to minimise the number of keyboards required and thus enabling larger keyboard buttons.

In order to type on tiny buttons on a virtual keyboard, we needed a slightly slower but more forgiving method than tapping which requires too much concentration and focus and is not tolerant to misses and inaccurate tapping. Thus, our invention the gesture or stroke input text inputting method. The gesture or stroke input text inputting method uses a slower step process (gesture) than tapping to become a more effective, accurate and fault tolerant method to select characters from an on-screen keyboard. The method is applicable to all manners of keyboard including QWERTY-type keyboards like the English, French and German keyboards and also non-QWERTY-type keyboards like the Fitaly (Textware™ Solutions Inc.—U.S. Pat. No. 5,487,616), Opti I, Opti II, Metropolis keyboard, and even Chinese keyboards, Japanese keyboards, etc.

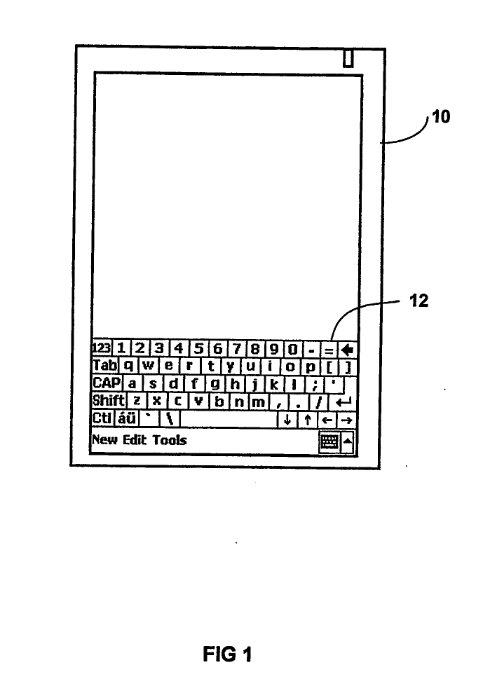

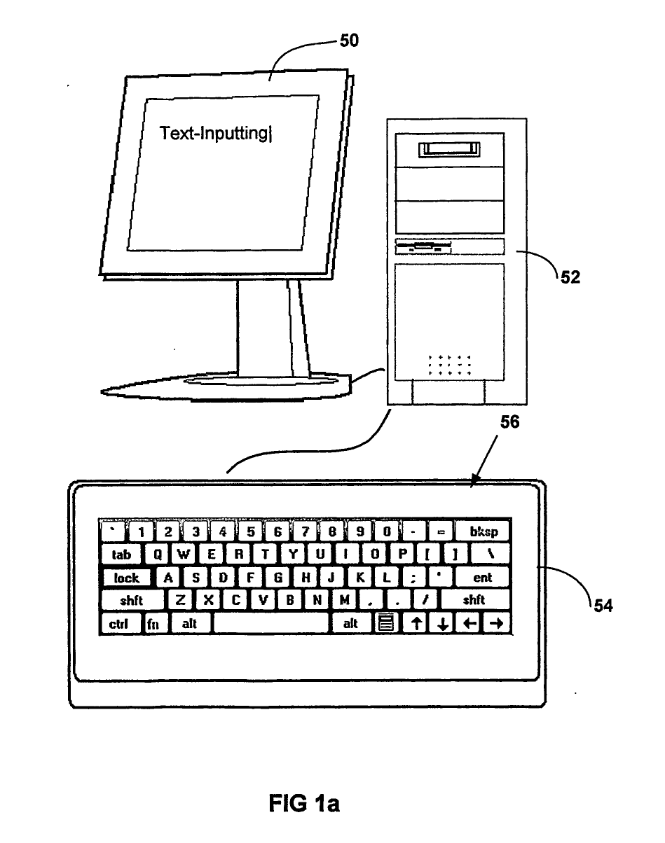

The idea and purpose of the invention is to have an input method that does not require as much concentration and focus as when tapping on small on-screen or on-pad keys and be more accurate, more fault tolerant and thus overall faster. This is also enhanced with our invention leaving a digital ink trace on the virtual keyboard which serves as a visual feedback for the user to adjust his text-inputting on the fly. This translates what was frequently a frustrating effort of concentrated tapping to a more fault tolerant thus enjoyable stroking gesture makes it even more provocative to use for screen-based text inputting or pen-based text inputting. An application for the invention would be for small, medium devices like mobile devices, PDAs, handhelds, Pocket PCs, mobile phones, tablet PCs or even virtual keyboards or any devices that uses screen-based or pen-based inputting. FIG. 1 shows how an on-screen implementation of a virtual keyboard 12 could look like on a handheld device 10. FIG. 1a shows how an on-pad implementation of a virtual keyboard 56 could look like on a typing surface pad 54. The surface pad 54 is usually linked to a computing processor 52 and the display 50 to which the text inputting appears is on a separate screen 50 which is linked to the same computing processor.

The embodiments depicted in the drawings, and the system discussed herewith may generally be implemented in and/or on computer architecture that is well known in the art. The functionality of the embodiments of the invention described may be implemented in either hardware or software. In the software sense, components of the system may be a process, program or portion thereof, that usually performs a particular function or related functions. In the hardware sense, a component is a functional hardware unit designed for use with other components. For example, a component may be implemented using discrete electrical components, or may form a portion of an entire electronic circuit such as an Application Specific Integrated Circuit (ASIC). There are numerous other possibilities that exist, and those skilled in the art would be able to appreciate that the system may also be implemented as a combination of hardware and software components.

Personal computers or computing devices are examples of computer architectures that embodiments may be implemented in or on. Such computer architectures comprise components and/or modules such as central processing units (CPU) with microprocessor, random access memory (RAM), read only memory (ROM) for temporary and permanent, respectively, storage of information, and mass storage device such as hard drive, memory stick, diskette, or CD ROM and the like. Such computer architectures further contain a bus to interconnect the components and control information and communication between the components. Additionally, user input and output interfaces are usually provided, such as a keyboard, mouse, microphone and the like for user input, and display, printer, speakers and the like for output. Generally, each of the input/output interfaces is connected to the bus by the controller and implemented with controller software. Of course, it will be apparent that any number of input/output devices may be implemented in such systems. The computer system is typically controlled and managed by operating system software resident on the CPU. There are a number of operating systems that are commonly available and well known. Thus, embodiments of the present invention may be implemented in and/or on such computer architectures.

The stroke input text inputting method can be implemented either by software, hardware or a hybrid of both. Generally, if its implemented purely via software, for example with a softkey (e.g. virtual keyboards on a touch screen) implementation, the device that the stroke input text inputting method is implemented on typically has an Operating System, a BIOS (Basic Input/Output System), a display and an input mechanism (e.g. touch screen and stylus). Then the software for the stroke input text inputting method may include a software program (that covers the methodology) written in a programming language supported by the operating system and a populated database, that covers the assignment of data values and data symbols with detection regions.

If the stroke input text inputting method is implemented with a reduced keyboard system in hardware, for example as a hardkey accessory, then the hardware may encompass a processor, a memory module like ROM/EPROM, an input mechanism such as buttons, keys, sensors and the like, and an interface socket to the device such as mobile devices, PDA, handheld computers, mobile phones, console devices and the like. Of course, the display could either be configured on the reduced keyboard system hardware or on the device. Various combinations are possible. The program and database could be stored in the memory modules and the processor a generic microprocessor that runs the program in the memory and relays the information to the display and interface socket. The program could also be mapped to the processor for example as in a digital signal processor (DSP) and the database stored in the memory module. Generally, the processor is the main central unit. On inputting on the input mechanism, a signal is sent to the processor. The processor may either process the signal for example if the program is stored in the processor or it will query the memory and process the information in the memory with regards to the signal from the input/output device. The processor of the hardware solution of the reduced keyboard system will then output signals to the display and/or via the interface socket to the device for example PDA, hardware accessory, and the like.

As a hybrid solution, the memory in the implemented device, for example a PDA or the like, could be used to store the program and database via a software or software driver and using the device's processor to process the program as similar to the first case discussed above. The hardware may include an input mechanism such as buttons, keys, sensors and an interface. If the input mechanism is built onto the device for example with additional buttons, then the interface may simply be wires or wireless means that connect and communicate to the device. If the input mechanism is on an external device, such as an accessory, then the interface may be like an interface socket like in the second case discussed above, and the display may be implanted on the hardware solution like in the earlier case with the accessory or using the display of the device.

Of course, to implement the reduced keyboard system in hardware, there may be connecting wires like circuit boards to house the circuitry, processors, memory, etc, and a housing that mounts the entire hardware part like buttons, display and the circuit board.

Scribing or Stroke Across

Because tapping is a near-instantaneous step process, it also makes it more tedious and frustrating to use to select small characters or characters on small virtual buttons, requiring lots of concentration and focus, yet still making many mistakes and needing to do a lot of error correction.

What is required is a slightly longer process step that takes the bite out of needing to concentrate as much and still be intuitive, easy and fast to use. The “slow-down” process step comes in the form of gesturing across the required character to input text instead of tapping on it.

Although many gestures could be used to delay the process step like circling, crossing, crisscrossing or zig-zagging, there is one preferred gesture which is the stroke across the character or scribing. Scribing is preferred as it would in general be faster than the other gestures yet provide enough delay to prevent needing to focus too intently on where you are scribing unlike tapping. This works for any touch screen input or screen with sensor pens or sensor input or even virtual keyboards or sensor pads with sensor pens or sensor detectors. Basically, all manner of characters can be scribed, be it numerals, alphabets, symbols or punctuations.

The scribing gesture is further enhanced with the use of a digital ink trace that is reflected on the virtual keyboard during the scribing motion. This gives a real-time visual feedback to the user, making it easier to make any adjustments “on the fly” and literally enables the user to “see” where he is scribing.

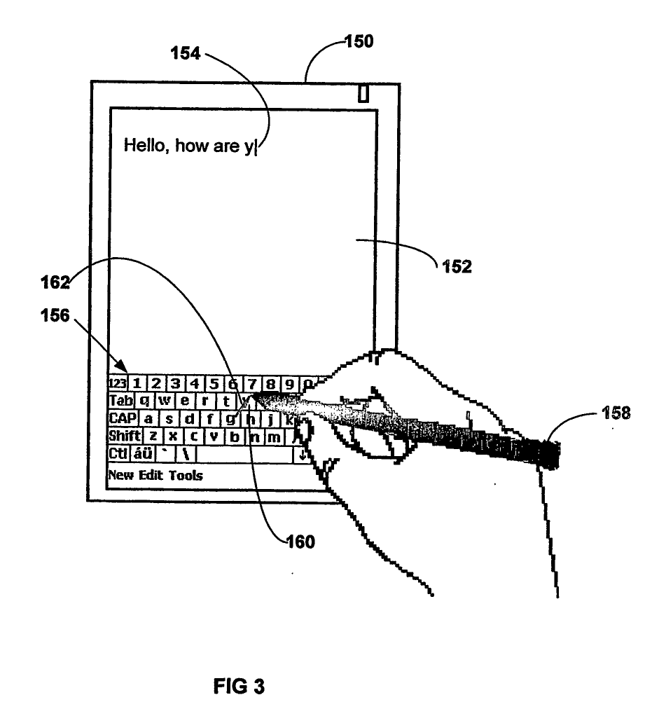

FIG. 3 shows an example of how scribing can be used to select a character on a virtual keyboard 156 for a handheld device 150. The user uses a stylus pen 158 or object to scribe on the character “y” 160 on the keyboard 156. This inputs the character onto wherever the text cursor currently resides 154 on the display 152. As it can be seen, the scribing could even start on a neighbouring character “g” 161 thus creating more flexibility and error tolerance for the user.
E.g. 1 To illustrate the effectiveness of scribing, take 2 small rectangles and place them slightly apart to simulate distance separation on an on-screen keyboard like below: 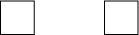
When comparing between rapidly alternating taps between the 2 rectangles and rapidly stroking across the 2 boxes. It would be seen that you would get more hits (touching the rectangles)/min, much less misses and requiring less effort (concentration) for scribing the rectangles.
Detection Region

The main mechanism in our invention to make scribing more effective and also to achieve not needing to focus and tap on the small buttons is the usage of detection regions. Previous gesture methods like those described in U.S. Pat. No. 6,286,064 and U.S. Patent Application 20030014239 all require initially contacting the key where the character is displayed.

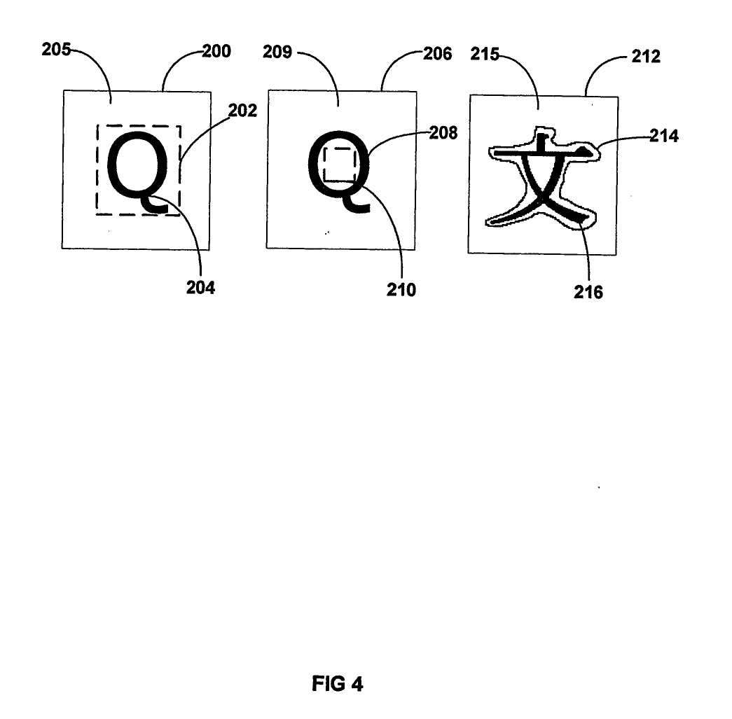

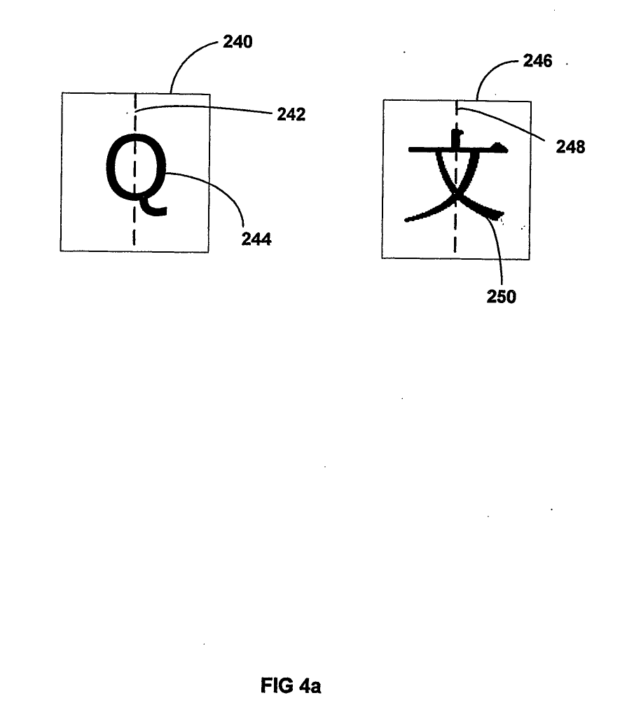

The detection region for a character can be a detection box (any shape or size) that either covers the character or is smaller and kept within the character. With the use of detection regions a user can start the scribe by touching the button space of another character and then slide through the detection region of the character that is required. FIG. 4 shows how detection regions 202, 210, 214 are allocated over characters 204, 208, 216 and the extra spaces 205, 209, 215 it creates between detection regions and the respective normal button spaces 200, 206, 212 to make selection of characters more fault tolerant. The detection region allows for more fault tolerance on the starting point of the scribing motion because of the increased space between detection regions (i.e. you can start scribing on any free space 205, 209, 215 without triggering any input), though too small a detection region may make it hard to detect the scribe over a character. As can be seen, detection regions work equally well for any characters or symbols (e.g. Chinese character 216).

Also in the prior art U.S. Patent Application 20030014239, the sliding method is used to select alternative forms of the character like accented, capital, extended characters or even command based functions while still relying on tapping for actual selection of the letter whilst in our invention, scribing is an improvement over tapping to select a character on a virtual keyboard unambiguously.

The detection region mechanism is even more greatly enhanced when used with the line detection region as discussed below which is the preferred embodiment of the invention.

Line Detection Region

FIG. 4a shows how the line detection region 242, 248 may be allocated over characters 244, 250 which are allocated a normal button space 240, 246. This embodiment creates even more spaces between line detection regions to make selection of characters even more fault tolerant (more space between line detection regions) yet barely reducing the difficulty of selecting the character via scribing. Again, line detection regions work equally well for any characters or symbols (e.g. Chinese character 250).
E.g. 2 To illustrate the effectiveness of line detection regions, take 2 small rectangles (to represent box detection regions) and place them slightly apart to simulate distance separation on an on-screen keyboard like below: 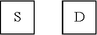
Next take 2 lines (to represent line detection regions) and place them slightly apart to simulate distance separation on an on-screen keyboard like below: [symbol]
When comparing between rapidly alternating scribing between the 2 rectangles and rapidly stroking across the 2 lines. It would be seen that it is much easier to scribe across the lines and require less concentration than scribing the rectangles because you would need to concentrate to avoid scribing the other region first.

Once you extrapolate the results for an entire virtual keyboard with all the characters close to each other, on all sides, and you would be able to see the effectiveness of the line detection regions. Detection lines can even be made visible on the virtual keyboard to facilitate scribing.

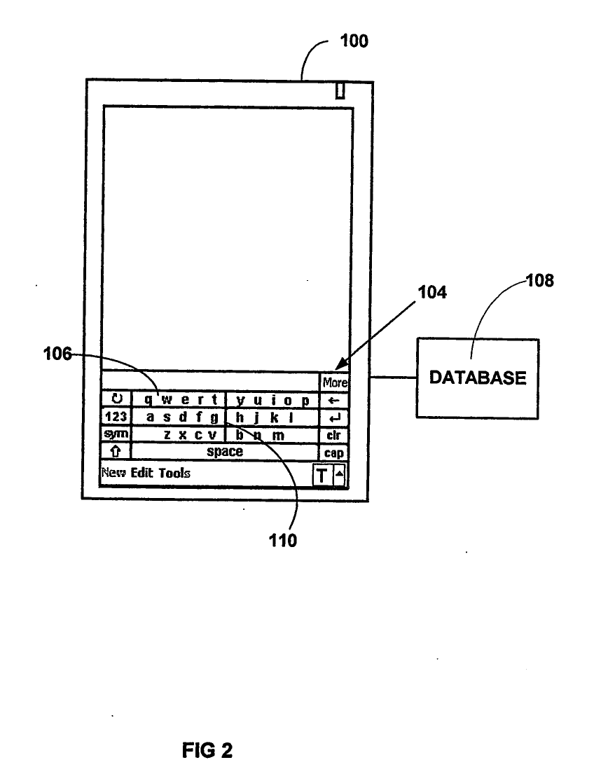

With line detection regions, this makes it possible to incorporate space consuming functions like the spacebar into a single line or a thin bar. The selection of the function would thus simply be to scribe across the line or thin bar as per a normal line detection region. As a line or thin bar, it would be much easier to implement/situate the function in an area or space to maximise text-inputting efficiency and minimise space taken up. An example of how a line spacebar could be implemented is shown by the vertical line 110 in FIG. 2.

The flexibility and power of detection regions is even further realised using rules for selection.

Rules of Selection

With detection regions, especially detection line regions, it is now very easy to scribe a character even with small virtual buttons, freeing up the concentration, focus and frustration normally associated with small buttons. Since now you can have the start point of the scribe in any location, you would need rules of selection to decide which characters scribed are being selected.

There are basically four rules that can be used to decide which characters are selected:
1. First detection region scribed across is the character selected
2. Last detection region scribed across is the character selected
3. The detection region scribed across the most is the character selected—For line detection regions that would mean the detection line that was scribed closest to the centre. For boxed detection regions, it could either be the detection region that was cut closest in half or the detection region that was gestured over the most (e.g. for gestures like circling, crisscrossing, zigzagging, etc.)
4. All detection regions scribed across are characters selected in the order they were scribed across

For rules 2 and 3, it would mean that either the selection decision can only be made after the touch contact is broken (e.g. the pen leaves the screen) or after a fixed time interval after contact with the surface. Rules 1 and 4 would not require the touch contact to be broken which makes it more flexible and provides the best reaction time and speed. Rule 1 is the preferred embodiment as it is more natural and allows for a more “casual” scribing as it does not require you to concentrate and focus on where your scribe goes after you have selected the character you wanted. In other words you can be more “lacklustre” in the scribing which reinforces the ease, naturalness and fun part of the invention without compromising speed or effectiveness. Using rule 1, unambiguous text inputting using the scribing method can be very fast and easy as you need not worry where you first touch and where your motion goes after scribing across the detection line you wanted. Selection of character is instantaneous on crossing the first detection line. This is unlike prior arts that either requires lifting the pen from the screen before a selection can be determined or requires a certain line and/or direction to be slid before character selection can be determined.

Inputting Special Characters or Functions

To input characters in a different case like capital letters, diacritic, accented, extended characters or even as a function call an auxiliary key is used in concert with the scribe. By selecting an auxiliary key and then selecting a character by scribing, special characters are displayed or a function is performed. The preferred embodiment would be to implement sticky auxiliary keys where the auxiliary need not be pressed simultaneously with the scribe. The auxiliary key need only be selected once before the scribe (a flag would be activated) and then followed by scribing the required character.

The special characters or functions are defined in a database as are the characters, data values and data symbols associated with each detection region.

Screen Text Input System

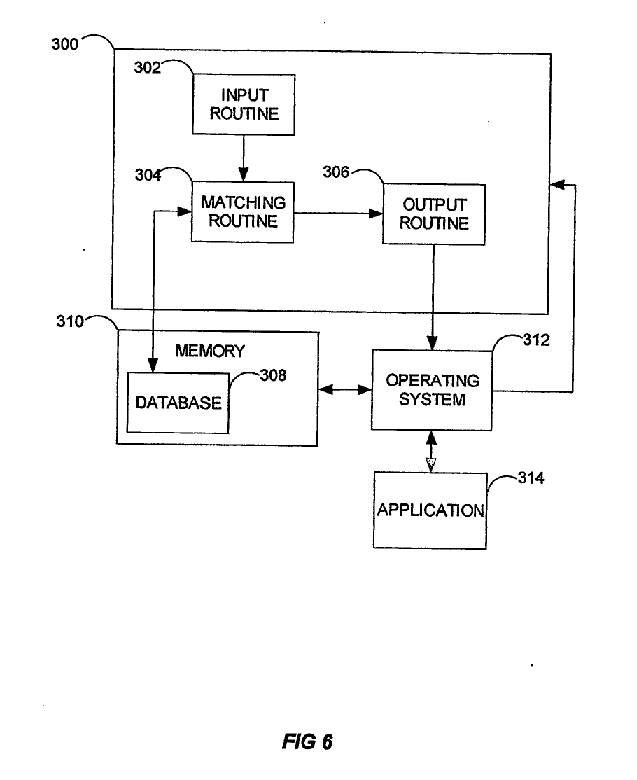

The gesture or stroke input text inputting method can be implemented on pen-based systems and devices as a software program or device driver. FIG. 6 shows the main components associated with a software program for screen text inputting system, in accordance with this invention. The screen text input system 300 would mainly comprise of a virtual keyboard display 306 with detection regions 302 at appropriate locations for inputting, a database 308 to store set of data values and data symbols assigned to the various detection regions which is representative of the displayed characters on the virtual keyboard and also any special characters or functions associated with sequence of auxiliary keys and detection regions, a software program 300 or device driver 300 with an input routine 302, matching routine 304 as well as an output routine 306. The database usually resides in the memory 310 and every application 314 (e.g. emails, word processing, spreadsheets), even the software program 300 or device driver 300 and memory, would function under the control of an operating system 312 such as Windows CE or Palm OS.

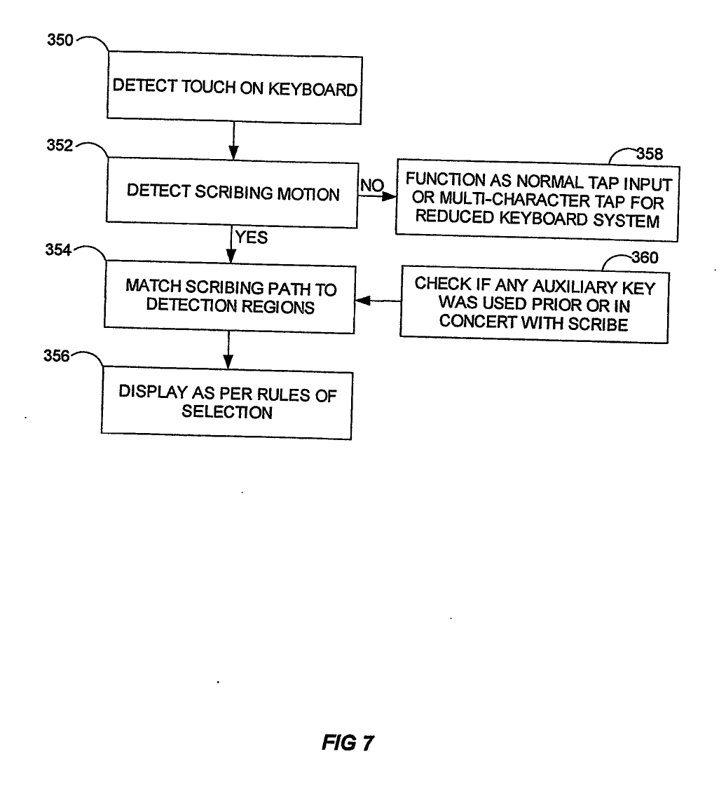

FIG. 7 shows the main steps associated with the operations of the software program. The input routine, as shown in 302 FIG. 6, would detect the touch on screen 350, followed by the scribing motion 352. At which point, the matching routine as had shown in 304 FIG. 6 would monitor the path of the scribe and tries to match it with any of the detection regions 354. Once a detection region is touched or crossed (i.e. using rule 1 of the rules of selection), the matching routine would retrieve the data value, data symbol, special character or function that matches the detection region scribed, in combination with any auxiliary keys pressed 360, and pass the information to the output routine as shown in 306 FIG. 6. The output routine would then display on the display of the device where the cursor or input point is currently positioned 356. If no scribing motion is detected in 352 following the touch 350 then the touch operates as per a normal touch input on the keyboard or normal multi-character if touched on a multi-character button on a reduced keyboard system 358.

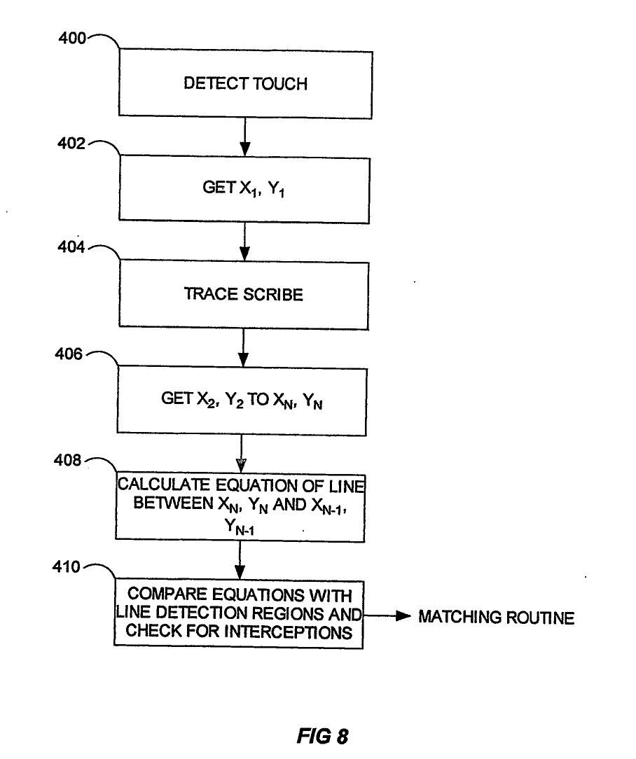

FIG. 8 shows how the input routine resolves the scribing motion and allows it to be matched with detection regions (i.e. line detection region). First a touch is detected on the virtual keyboard 400, the coordinate for the contact is retrieved as X₁ and Y₁ 402. The scribing motion is traced and each coordinate detected is retrieved 404 in discrete time intervals (1 to n), usually determined by the operating system, as Xₙ and Yₙ 406. Line equations are calculated as scribing progresses from Xₙ₋₁ and Yₙ₋₁ to Xₙ and Yₙ 408 and these line equations are matched during the scribing process 410 with the line detection region's equations to see if any line region is scribed over (i.e. interception between the 2 line equations).

The database that store the set of data values and data symbols assigned to the various detection regions as well as any auxiliary key plus detection region combos could look like:

| Detection Region | Character |
|---|---|
| X₁Y₁, X₂Y₂ | q |
| X₃Y₃, X₄Y₄ | w |
| X₅Y₅, X₆Y₆ | e |
| X₇Y₇, X₈Y₈ | r |
| X₉Y₉, X₁₀Y₁₀ | t |
| . . . | . . . |

Where X₁Y₁, X₂Y₂ shows the coordinates (Xₓ is coordinate for the horizontal axis while Y_{y} is the coordinate for the vertical axis) of the opposing coordinates of a detection rectangle box. In the case of other shapes besides a rectangle being used (e.g. triangle) more coordinates could be used or in the case of a circle, a centre point and its radius. For the preferred embodiment of detection line regions, X₁Y₁, X₂Y₂ would be X₁Y₁, X₁Y₂ for a vertical line or X₁Y₁, X₂Y₁ for a horizontal line.

For auxiliary keys plus detection region combos, the database could look like:

| Auxiliary key, Detection Region | Characters |
|---|---|
| shift, X₁Y₁, X₂Y₂ | Q (capital/upper case) |
| shift, X₃Y₃, X₄Y₄ | W |
| shift, X₅Y₅, X₆Y₆ | E |
| aux1, X₅Y₅, X₆Y₆ | é |
| aux2, X₅Y₅, X₆Y₆ | ê |
| aux3, X₅Y₅, X₆Y₆ | ë |
| . . . | . . . |

Thus in the above database example, pressing shift (sticky shift) and then scribing the detection region X₅Y₅, X₆Y₆ would select and display the character “e” in the upper case, “E” while pressing the auxiliary key 1 (sticky aux) and then scribing the detection region X₅Y₅, X₆Y₆ would select and display the character “é”.

To make the matching routine more efficient, the detection regions are stored in the order of the most commonly scribed character to the least commonly scribed character. This most common letter used list could be obtained easily in any preferred or referenced statistic. By using a simple common letter used list to set-up the database this ensures that the matching routine would always match the scribing coordinate/equation with the most likely (most common) detection region first proceeding to the next most likely and so on.

An example of the characters in the English language (if used on a QWERTY keyboard layout) arranged in order of most commonly used to least commonly used character could be:

E,T,A,O,I,N,S,H,R,D,L,C,U,M,W,F,G,Y,P,B,V,K,J,X,Q,Z

Thus the database that store the set of data values and data symbols assigned to the various detection regions could look like:

| Detection Region | Character |
|---|---|
| X₁Y₁, X₂Y₂ | e (most common) |
| X₃Y₃, X₄Y₄ | t |
| X₅Y₅, X₆Y₆ | a |
| . . . | . . . |
| X₂₆Y₂₆, X₂₆Y₂₆ | z (least common) |

Reduced Keyboard Systems

The stroke input text inputting method is especially useful for unambiguous text inputting for reduced keyboard systems, e.g. TenGO (Singapore Patent Application 200202021-2). For virtual reduced keyboard systems, it allows unambiguous text inputting to be done without the need to switch modes from the normal ambiguous text inputting or the need for additional buttons. It is also a direct unambiguous text inputting method that does not require alternative multi-step methods like multi-tap and two-step methods covered in U.S. Pat. Nos. 6,011,554 and 6,307,549 for reduced keyboard systems.

The main factor is that the stroke input text input system can differentiate between a scribe and a tap, thus being able to distinguish unambiguous text input (scribe) and ambiguous text input (tap) simultaneously. The using of a slide method to seamlessly distinguish between ambiguous and unambiguous text inputting for reduced keyboard systems was previously addressed in U.S. Pat. No. 6,286,064, but the sliding motion still necessitates first touching each symbol on each key precisely. With our improved stroke input text inputting system, this is no longer necessary. In fact, there need not be any individual virtual keys to represent the individual characters that make up the multi-character key 106 as shown in FIG. 2. FIG. 2 shows how a reduced keyboard system could be implemented on a handheld device 100. The reduced keyboard system would normally consist of a virtual keyboard 104 made-up of multi-character buttons 106 and a database 108. The characters are displayed as normal on the multi-character key and tapping on the multi-character key would trigger ambiguous text input which would be resolved with a disambiguating algorithm, while scribing on the individual characters (i.e. detection regions) would trigger unambiguous text input and display the character representative of the first detection region scribed (i.e. using rule 1 of the rules of selection). This would make using virtual reduced keyboard systems on pen-based devices much easier and faster when switching between unambiguous and ambiguous text inputting.

This same methodology can be applied to reduced keyboard systems using physical keys as well, by simply using physical multi-character keys that are capable of simulating a “scribe” motion counter to the normal tapping or pressing of the keys. In our invention, there are two preferred embodiments to implement the stroke input text input methodology for physical reduced keyboard systems.

Normally, the reduced keyboard systems could be represented in two main ways, either as large buttons, that could be implemented to resemble much like a normal keyboard, but with individual characters sharing the same multi-character key (to compress space and utilising a larger button to improve text inputting) as described in Singapore Patent Application 200202021-2, or as small buttons that does not resemble a normal keyboard but to minimise space utilised by the keyboard as described in U.S. Pat. Nos. 5,818,437; 5,945,928; 5,953,541; 6,011,554; 6,286,064, 6,307,549, and Singapore Patent Application 200202021-2.

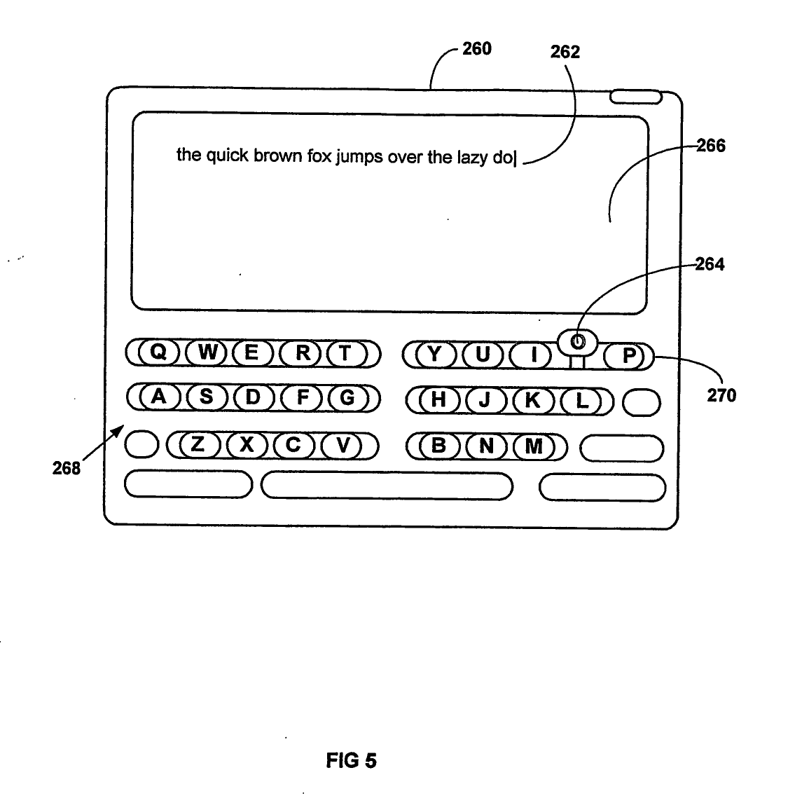

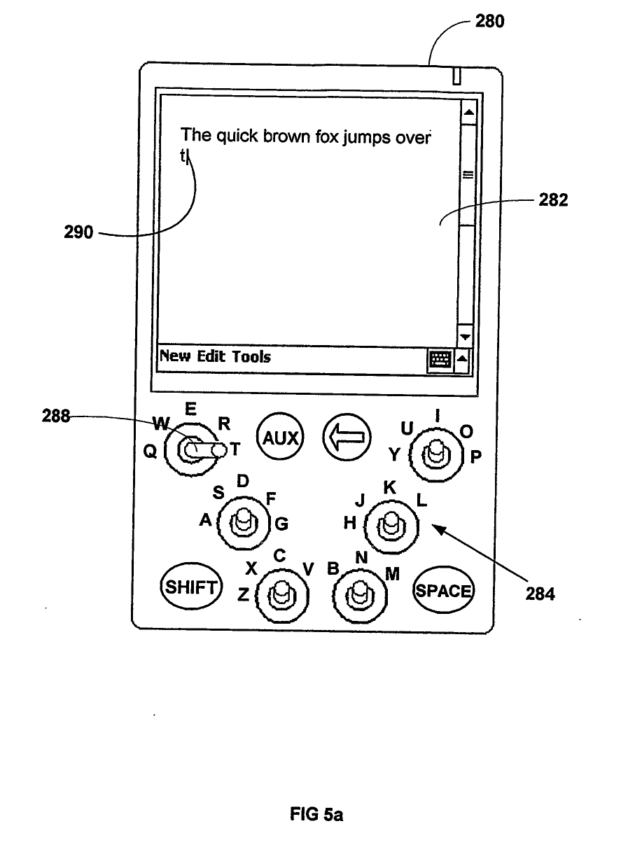

For the larger buttons devices, the scribing methodology can be implemented in the form of the physical multi-character key consisting of individual keys, representative of the consisting characters 264 of the multi-character key 270 that could be moved counter to the tapping motion as shown in FIG. 5. FIG. 5 shows how a keyboard using this methodology/mechanism 268 could be implemented on a handheld device 260. When tapped or pressed, the individual buttons 264 move together as one 270 and input as per a normal multi-character key input. The individual keys however are able to move in a direction counter to the tapping motion (e.g. up or down) and this motion would simulate a “scribing” motion and input as an unambiguous text input and display the individual character as represented by the individual keys. In FIG. 5, the individual key “O” 264 is moved up thus inputting the character “o” to where the text cursor currently resides 262 in the display 266. Of course if an “up” motion is used for unambiguous text inputting, a “down” motion could be used to input special characters or even functions.

For physical reduced keyboard systems using smaller keys or only having a smaller area for keyboard (i.e. smaller form factor), the scribing methodology can be implemented in the form of the physical multi-character key being a button that could move in multiple directions in addition to the normal tapping movement (e.g. a joystick-like button 288) as shown in FIG. 5a. FIG. 5a shows how a keyboard 284 using joystick-like buttons 288 could be implemented on a handheld device 280. Thus, to input individual characters unambiguously, each direction would represent each individual character in the set of characters (e.g. “Q”, “W”, “E”, “R”, “T”) represented by the multi-character key 288. Because generally a multi-character key would not represent more than five characters in the base set (without the use of auxiliary keys or menu/selection lists), the preferred embodiment would be the multiple directions to be the five directions in a forward semi-circle as shown in FIG. 5a. In FIG. 5a, the multi-character key 288 is moved right thus inputting the character “t” to where the text cursor currently resides 290 in the display 282. Of course, lesser directions could be used for multi-character keys representing less than 5 characters or more directions (e.g. backward semi circle directions, pull-up, clockwise and counter-clockwise twists, etc.) could be implemented to accommodate non-base character sets as well like capital, accented, extended or diacritic characters or even functions. Thus moving the button in the various directions would unambiguously select/display the data value or data symbol or even function associated with the button and direction it was moved. This would seamlessly integrate unambiguous text inputting (directional inputting) and ambiguous text inputting (tapping) for the physical reduced keyboard system.

Of course, the unambiguous text inputting for reduced keyboard systems would operate as per a normal unambiguous text inputting for functions like saving new words to library.

Some design factors taken into consideration for the gesture or stroke input text inputting methodology and implementation was the frustration when tapping on small soft-keys on screen for small mobile devices like handhelds, PDAs, mobile phones, pocket PCs and tablet PCs. The requirements were for better and more efficient ways to input text without compromising display screen size (i.e. larger buttons), fast adoption and a low learning curve, and be compatible with all manners of keyboards, which includes QWERTY-type keyboards like the English, French and German keyboards and also non-QWERTY-type keyboards like the Fitaly (Textware™ Solutions Inc.—US. Pat. No. 5,487,616), Opti I, Opti II, Metropolis keyboard, and even Chinese keyboards, Japanese keyboards, etc. The methodology developed was also to be implementable on reduced keyboard systems which use multi-character keys so as to provide seamless implementation of unambiguous text inputting for reduced keyboard systems (using either virtual keys or physical keys), without the need of a mode change function between ambiguous and unambiguous text input.

Since tapping on small buttons or characters was the problem, we needed a process step that had a more flexible starting point and took a slightly longer time than tapping so that it allowed for adjustments on the fly, but would speed text-inputting overall because of lesser frequencies of errors and less user frustration and heightened user experience because of a lesser need to focus and concentrate (as it is accuracy tolerant and allows for adjustments). Thus, the concept of gesture or stroke based text inputting was developed. The preferred embodiment of gesture is the stroke across or scribing, but all other gestures like circling, crossing, criss-crossing, or zig-zagging, etc. is applicable albeit slower. Therefore, with scribing, all you need to do with a stylus, finger or object is to stroke across any character of the keyboard on screen and the character is inputted. Scribing does not necessitate having the start point to be on the character itself. In fact, the starting point could be on another button and the motion of the scribe to pass through the wanted character to input it. This works for any touch screen input or screen with sensor pens or sensor input or even virtual keyboards or sensor pads with sensor pens or sensor detectors. Basically, all manner of characters can be scribed, be it numerals, alphabets, symbols, punctuations, etc.

An enhancement of scribing would be to have a digital ink trace be shown on the virtual keyboard while scribing to serve as a visual feedback and guide the user in his scribing action.

To make scribing even more effective, instead of making the character the detection region, a detection box (any shape or size) can be used that either covers the character or is smaller and kept within the character. The preferred embodiment of the detection region is a line across the character (that could be visible or invisible to the user). All a user need to do is to scribe across the line and the character is considered stroked across. This allows for super-fast scribing action and even adds a fun element to text inputting. A further use of line detection is to reduce space consuming functions such as the spacebar into a single line or thin bar. Thus the selection of the function is simply to scribe across the line representing the function. As a line or thin bar, it would be much easier to place the function in an area to minimise space taken up and optimise text inputting flow.

The logic to determine which character is being scribed could either be the first character scribed, last character scribed or the character scribed over the most (percentile of region of detection region scribed over) after the stylus leaves contact with the screen/surface or after a predetermined time interval on start of scribing. In using the preferred embodiment of a line across the character to be used as the detection region, then the preferred logic for determining character scribed is the first character whose detection line is scribed across.

The scribing element could be used in concert with any auxiliary key or sticky auxiliary key (sticky meaning need only press the auxiliary key once without need to keep holding down the key to work in concert with other keys—e.g. sticky shift) to generate special variations of the character scribed like uppercase, diacritic characters or even as function calls.

The scribing method works great with multi-character keys in reduced keyboard systems because it need not override the original ambiguous tapping function, as a scribe is distinctively different from a tap. Thus, for a multi-character button, as used by reduced keyboard systems like TenGO or numeric phone pad systems like T9® (by Tegic Communications, Inc), iTAP™ (by Motorola, Inc), eZiText® (by Zi Corporation), or WordWise® (by Eatoni Ergonomics, Inc), when a user taps the multi-character button, the normal function is triggered, be it predictive text inputting or multi-tapping, but if a scribe occurs over a particular character of the multi-character set, then the character is inputted unambiguously and seamlessly.

The extension of this method applies to hard-key implementation of reduced keyboard systems as well. This requires some alterations to the hard buttons. Besides a larger multi-character button that can be pressed, the button also consists of individual buttons representing the individual characters of the character set that can be moved counter to pressing (e.g. pulled up, push forwards or pushed backwards). Another alternative is for the multi-character button to have joystick like movement capabilities or radial pressing capabilities, besides pressing straight down, with each movement or directional press representing a character of the character set of the multi-character button.

In view of the above description, the essence of an embodiment of the present invention is to provide a less frustrating method to unambiguously input text on small virtual buttons and also to seamlessly integrate unambiguous text inputting and unambiguous text inputting. Although the references are for characters, the teachings of the present system could easily be extended to any symbol, numeral, or function. Numerous embodiments of the teachings of the present invention beyond those specifically described here are possible and which do not extend beyond the scope of those teachings, which scope is defined by the appended claims. In particular, applications of the system are not limited to the standard unambiguous code or to applications only in mobile devices or conventional devices requiring text input, but are well suited for other applications and embodiments, even futuristic (less conventional) ones like writing surface pads, sensor pens and optical or movement recognition input devices, or any electronic device requiring a means to input a string of non-random characters as long it could detect coordinates or differentiate scribing motion.

The text input methodology described here may also be mixed-and-matched with other well-known word completion mechanisms to further reduce the number of keystrokes required for some varieties of text input. Additionally, that not all the methodology and mechanisms need be implemented to complete the reduced keyboard systems as long as its essence remains and main text input functions are intact, thus allowing for the omission of certain methodologies and mechanisms to reduce cost, software size, implementation requirements and/or even some good-to-have (but not critical) functionalities.

It will be appreciated that, although specific embodiments of the invention have been described herein for purposes of illustration, various modifications may be made without departing from the scope of the invention. Accordingly, the invention is not limited except by the appended claims.

What is claimed is:

1. A method of inputting for a screen text input system, wherein to input a data value or data symbol on a virtual keyboard unambiguously using a gesture and stroke text input method comprising the steps of:
using a finger or object to stroke across a character representative of a keystroke on a virtual keyboard on the screen;
detecting the touch on the screen;
detecting the stroking motion from the point of contact on the screen;
matching location points of the stroking path with detection regions on the screen, which are assigned data value or data symbols representative of the character displayed on the screen, it is located on or nearby;
and displaying as text input the data value or data symbol assigned to the detection region that is stroked across.

2. A method of inputting as claimed in claim 1 wherein gestures also includes besides a stroke across, circling, crossing, crisscrossing and zigzagging over the character and have the same functionality as a stroke across.

3. A method of inputting of claim 2 wherein the gesture leaves behind a digital ink trace on the virtual keyboard during gesturing.

4. A method of inputting of claim 1 wherein the matching of location points of the stroking path with detection regions on the screen, are done in the order of matching with the most likely or common detection region first to the least likely or common detection region last.

5. A method of inputting of claim 1 wherein the detection region representative of the character is a detection box within or covering the character and the detection box can be of any shape and size.

6. A method of inputting of claim 1 wherein the detection region representative of the character is a detection line across or near the character.

7. A method of inputting of claim 6 wherein the detection line is visible on the keyboard.

8. A method of inputting of claim 6 wherein a spacebar is represented by a single line or thin bar on the virtual keyboard wherein it is selected as per a detection line.

9. A method of inputting of claim 1 further comprising the step:
performing as per a normal button input, if the character or button representing the character is tapped instead of gestured over.

10. A method of inputting of claim 1 further comprising the step:
displaying the data value or data symbol in a different case like upper case, diacritic and accented type case or even as a function, if an auxiliary key or sticky auxiliary key is used in concert with the gesture.

11. A method of inputting of claim 1 wherein the character displayed is the first character gestured over ignoring any subsequent characters that could have been gestured over.

12. A method of inputting of claim 1 wherein the character displayed is the last character gestured over ignoring any previous characters that could have been gestured over.

13. A method of inputting of claim 1 wherein the character displayed is the character that was gestured over the most ignoring any other characters that have been gestured over less.

14. A method of inputting of claim 6 wherein the character displayed is the character that was gestured closest to the centre of the detection line ignoring any other characters that have been gestured further from the centre of their detection line.

15. A method of inputting of claim 1 wherein characters are displayed for each character that was gestured over in the order of which they were gestured over.

16. A method of inputting of claim 1 wherein the screen could be a touch screen or sensor pad, or a screen or virtual screen that works with a sensor object or sensor like in pen-based inputting.

17. A method of inputting of in claim 1 wherein the character could be one of the characters in a multi-character key.

18. A method of inputting of claim 17 further comprising the step:
performing as per a multi-character key input, if the character or multi-character key representing the character is tapped instead of stroked across.

19. A screen text input system comprising:
a display routine displaying a virtual keyboard on screen;
a stored set of data values and data symbols assigned to various detection regions on the virtual keyboard representative of the displayed characters on the virtual keyboard;
an input routine which detects a touch on the virtual keyboard and a scribing path of the contact with the virtual keyboard;
a matching routine which matches the detection regions of the virtual keyboard with the scribing path and determines which detection region(s) is selected; and an output routine that displays the data value or data symbol representative of the detection region(s) selected.

20. A screen text input system of claim 19 wherein the scribing path of the contact with the virtual keyboard leaves behind a digital ink trace on the virtual keyboard during scribing.

21. A screen text input system of claim 19 wherein the matching routine matches the detection regions of the virtual keyboard with the scribing path in the order of matching with the most likely or common detection region first to the least likely or common detection region last.

22. A screen text input system of claim 19 wherein the detection region representative of the character is a detection box within or covering the character and the detection box can be of any shape and size.

23. A screen text input system of claim 19 wherein the detection region representative of the character is a detection line across or near the character.

24. A screen text input system of claim 23 wherein the detection line is visible on the virtual keyboard.

25. A screen text input system of claim 23 wherein a spacebar is represented by a single line or thin bar on the virtual keyboard wherein it is selected as per a detection line.

26. A screen text input system of claim 19 wherein the input routine detects a touch without a scribing path on the virtual keyboard as per a normal button input.

27. A screen text input system of claim 19 wherein to display a data value or data symbol in a different case like upper case, diacritic and accented type case or even as a function, an auxiliary key or sticky auxiliary key is used in concert with the scribe.

28. A screen text input system of claim 19 wherein the matching routine determines that the detection region selected is the first detection region scribed over ignoring any subsequent detection regions that could have been scribed over.

29. A screen text input system of claim 19 wherein the matching routine determines that the detection region selected is the last detection region scribed over ignoring any previous detection regions that could have been scribed over.

30. A screen text input system of claim 19 wherein the matching routine determines that the detection region selected is the detection region that was scribed over the most ignoring any detection regions that have been scribed over less.

31. A screen text input system of claim 23 wherein the matching routine determines that the detection region selected is the detection line that was scribed closest to the centre of the detection line ignoring any detection lines that have been scribed further from the centre of their detection line.

32. A screen text input system of claim 19 wherein the matching routine determines that detection region(s) are selected for each detection region that was stroked over in the order of which they were stroked over.

33. A screen text input system of claim 19 wherein the screen can be a touch screen or sensor pad, or a screen or virtual screen that works with a sensor object or sensor like in pen-based inputting.

34. A screen text input system of claim 19 wherein the virtual keyboard is a reduced keyboard system with multi-character keys with each multi-character key displaying its set of consisting characters.

35. A screen text input system of claim 34 wherein the input routine detects a touch without a scribing path on the multi-character key as per a normal multi-character key input.

36. A method of inputting for a reduced keyboard system, with a plurality of keys, each key having at least one feature wherein the feature is a data value, a function or a data symbol representative of a keystroke on a keyboard, wherein a key is a multi-character key consisting of individual character keys, representative of the consisting individual data value or data symbol, that can move in a counter motion to the normal motion of tapping on the multi-character keys, wherein to input a character unambiguously does not require changing modes between ambiguous and unambiguous text-inputting using a stroke text input method comprising the steps of:
moving the individual character key in a direction counter to tapping as per normal for a multi-character key input; and
displaying the data value or data symbol representative of the individual character key.

37. A method of inputting of claim 36 wherein instead of the multi-character key consisting of individual character keys, it is a single button that can be moved in multiple directions besides tapping, wherein each direction represents the stroke text input method of moving the consisting individual character key counter to tapping.

38. A method of inputting of claim 36 further comprising the step:
displaying the data value or data symbol in a different case like upper case, diacritic and accented type case or even as a function, if an auxiliary key or sticky auxiliary key is used in concert with moving of the individual character key counter to tapping.

39. A method of inputting of claim 36 further comprising the steps:
performing as per a normal multi-character key input, if the button representing the character is tapped instead of stroked and moved counter to tapping.

40. A method of inputting of claim 39 wherein if more than one individual character key from the same multi-character key set is tapped together, it would still perform as per a single multi-character key input.

41. A reduced keyboard system for inputting information comprising:
a plurality of keys, each key having at least one feature wherein the feature is a data value, a function or a data symbol representative of a keystroke on a keyboard wherein a key is a multi-character key consisting of individual character keys, representative of the consisting individual data value or data symbol, that can move in a counter motion to the normal motion of tapping on the multi-character keys;
a database for storing data wherein the data is a data character or a data symbol associated with an input keystroke sequence of the keys; and
a display for displaying the information.

42. A reduced keyboard system of claim 41 wherein to input a character unambiguously does not require changing modes between ambiguous and unambiguous text-inputting by moving a individual character key in a direction counter to tapping as per normal for a multi-character key input.

43. A reduced keyboard system of claim 41 wherein instead of the multi-character key consisting of individual character buttons; it is a single button that can be moved in multiple directions besides tapping, wherein each direction represents the equivalent of moving of the consisting individual character key counter to tapping.

44. A reduced keyboard system of claim 43 wherein to input a character unambiguously does not require changing modes between ambiguous and unambiguous text-inputting by moving a button in a direction, representative of the consisting individual data value or data symbol, counter to tapping as per normal for a multi-character key input.

45. A reduced keyboard system of claim 41 wherein to input data value or data symbol in a different case like upper case, diacritic and accented type case or even as a function, an auxiliary key or sticky auxiliary key is used in concert with moving of the individual character key counter to tapping.

46. A reduced keyboard system of claim 43 wherein to input data value or data symbol in a different case like upper case, diacritic and accented type case or even as a function, an auxiliary key or sticky auxiliary key is used in concert with moving of the button in a direction, representative of the data value or data symbol, counter to tapping.

47. A reduced keyboard system of claim 41 wherein to input as per a multi-character key input, the multi-character key representing the character is tapped.

48. A reduced keyboard system of claim 43 wherein to input as per a multi-character key input, the multi-character button representing the character is tapped.
